(19) United States
(12) Patent Application Publication
(10) Pub. No.: US 2014/0072476 A1
(43) Pub. Date: Mar. 13, 2014

(54) IONIZATION DEVICE, MASS SPECTROMETER INCLUDING THE IONIZATION DEVICE, AND IMAGE GENERATION SYSTEM

(71) Applicant: CANON KABUSHIKI KAISHA, Tokyo (JP)

(72) Inventor: Yoichi Otsuka, Kawasaki-shi (JP)

(21) Appl. No.: 14/016,633

(22) Filed: Sep. 3, 2013

(30) Foreign Application Priority Data
Sep. 7, 2012 (JP) 2012-197208

(51) Int. Cl. H01J 49/14

(52) U.S. Cl. CPC H01J 49/145
USPC 422/83; 422/547

(57) ABSTRACT

A sample and a reagent are disposed separately. The reagent is taken into a liquid at a leading end of a needle, and a voltage is applied thereto to turn the liquid into fine liquid droplets. The sample is irradiated with laser light to cause the sample to be emitted into a space in the form of fine particles. The fine liquid droplets and the fine particles are brought into contact in the space to obtain ionized fine particles.

### BACKGROUND OF THE INVENTION

1. Field of the Invention

The present invention relates to ionization devices for ionizing samples, mass spectrometers including such ionization devices, and image generation devices for generating images on the basis of mass spectrometry results.

2. Description of the Related Art

There exists a technique for ionizing a sample in an atmospheric pressure environment in order to analyze components in the surface of the sample.

Japanese Patent Laid-Open No. 2008-147165 discusses a method for sampling from a fine region of a sample and ionizing the sample, in which laser light and electrospray ionization are combined. According to this method, a solid material (sample) on a substrate is first irradiated with laser light in an atmospheric pressure environment, and a portion of the solid material in a fine region thereof is desorbed in the form of fine particles. Then, charged liquid droplets from an electrospray are sprayed on the fine particles to ionize components in the fine particles (i.e., ions are obtained). Thereafter, the generated ions are introduced into a mass spectrometer to measure a mass-to-charge ratio of the ions, and thus the components are analyzed.

U.S. Pat. No. 7,718,958 discusses a method in which a specific reagent is mixed in advance into a solvent to be electrosprayed to allow the reagent to be contained in charged liquid droplets.

According to the method discussed in U.S. Pat. No. 7,718,958, the reagent that chemically reacts with a substance to be analyzed is mixed in advance into the solvent to be electrosprayed. Fine particles of the substance to be analyzed that have been desorbed as a result of being irradiated with laser light chemically react with the reagent in a millisecond range and are ionized. A method for analyzing the substance on the basis of a distribution pattern of ions of a reaction product is discussed.

According to the method discussed in Japanese Patent Laid-Open No. 2008-147165, the surface of the sample is irradiated with the laser light to sample the components in the sample in the form of fine particles at high speed and with ease, and ionization can be carried out. Meanwhile, if the sample is irradiated with the laser light, fine particles containing a variety of components are generated simultaneously and ionized. Accordingly, a mass spectrum that is ultimately obtained includes multiple peaks resulting from the various components, and it is difficult to analyze components having similar mass-to-charge ratios separately from one another.

With the method discussed in U.S. Pat. No. 7,718,958, since the reagent that reacts with a specific component in the substance to be analyzed is added in advance to the solvent to be electrosprayed, similar components can be separated from one another, which facilitates interpretation of the test result. Meanwhile, when multiple reagents are to be used, multiple solutions in which distinct reagents have dissolved are introduced into electrospray devices, respectively. In that case, in order to analyze a substance that contains a plurality of components, a plurality of reagents needs to be allowed to react, which requires time and effort.

### SUMMARY OF THE INVENTION

According to an aspect of the present invention, an ionization device includes a support configured to support a sample, a laser light irradiation unit configured to irradiate the sample supported on the support with laser light, a needle configured to hold a liquid at a distal end thereof, a voltage application unit configured to cause the liquid held at the distal end of the needle to scatter in a space in the form of liquid droplets, and a reagent holding unit that is disposed away from the sample and is configured to hold a reagent. In such an ionization, a substance contained in the sample is ionized and scattered, and, the needle is configured to hold the liquid that includes the reagent that has been held by the reagent holding unit.

According to an exemplary embodiment of the present invention, a reagent placed on a substrate can be emitted into a space, and thus the reagent does not need to be mixed into a liquid in advance. Furthermore, a sample can be prevented from coming into contact with the reagent while components in the sample are ionized.

In addition, the sample is disposed in one direction so that the position on the sample that are to be irradiated with laser light shifts in one direction, and distinct types of reagents are arranged on a substrate in the same direction as the aforementioned one direction. Thus, as the position to be irradiated with the laser light shifts, a component in the sample can be ionized using a different reagent.

Further features of the present invention will become apparent from the following description of exemplary embodiments with reference to the attached drawings.

### BRIEF DESCRIPTION OF THE DRAWINGS

FIG. 1 is a schematic diagram illustrating an image generation system that includes an ionization device according to a first exemplary embodiment.

FIG. 2 is a schematic diagram illustrating an image generation system that includes an ionization device according to a second exemplary embodiment.

FIG. 3 is a schematic diagram illustrating a face of a substrate included in a support of an ionization device according to a third exemplary embodiment.

FIG. 4 is a schematic diagram illustrating a face of a substrate included in a support of an ionization device according to a fourth exemplary embodiment.

FIG. 5 is a schematic diagram illustrating a synchronization circuit of an ionization device according to an exemplary embodiment of the present invention.

### DESCRIPTION OF THE EMBODIMENTS

### First Exemplary Embodiment

An ionization device according to a first exemplary embodiment of the present invention includes a reagent holding unit disposed at a location separated from a position at which a sample is supported, a laser light irradiation unit for scattering fine particulate matter of the sample, a needle for holding a liquid at one end thereof, and a voltage application unit for ionizing the liquid and causing the ionized liquid to be emitted into a space.

The laser light irradiation unit is disposed so as to be capable of irradiating a desired location on the surface of the sample with laser light emitted from a laser light source.

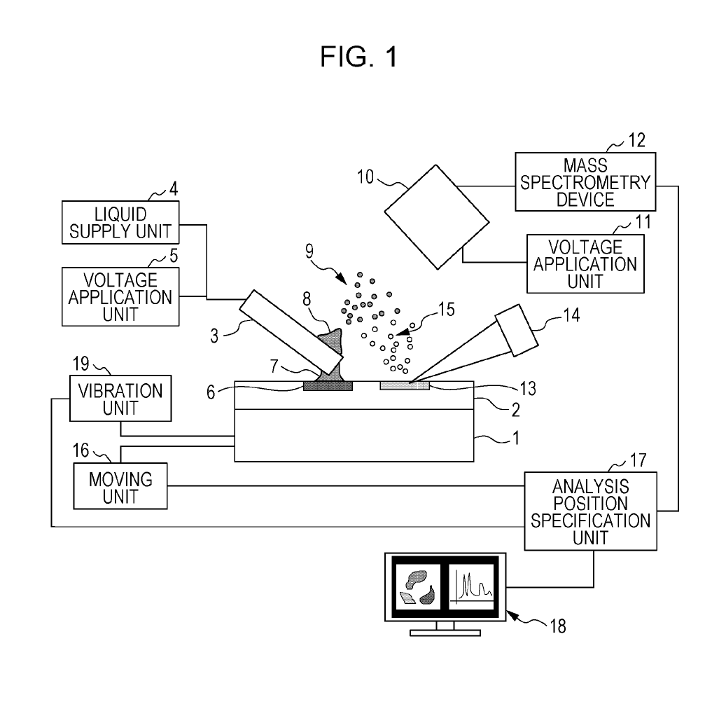

FIG. 1 is a schematic diagram illustrating an image generation system that includes the ionization device according to the first exemplary embodiment of the present invention.

A substrate 2 is supported by a support 1, and a reagent 6 and a sample 13 are held on the substrate 2. A reagent holding unit (holding unit) for holding the reagent 6 is provided in the substrate 2. The sample 13 is a substance obtained from biological tissue and is a section (cell group), blood, or homogenized cells. A probe 3 serving as a needle is disposed such that an end thereof is in contact with or, as illustrated in FIG. 1, is in close proximity to the reagent 6. A flow channel (not illustrated) is formed inside the probe 3, and a liquid is supplied to the surface of the reagent 6 through the flow channel. The liquid is a solvent in which a substance contained in the reagent 6 can dissolve as a solute, and in the first exemplary embodiment, this liquid is a mixture of water, an organic solvent, and an acid or a base.

As this liquid makes contact with the reagent 6, the reagent 6 dissolves in the liquid. Here, “dissolving in a solvent” refers to a state where molecules, atoms, or fine particles are dispersed in the solvent.

The liquid is continuously supplied to the probe 3 from a liquid supply unit 4, and the liquid supplied to the probe 3 forms a liquid bridge 7 between an end of the probe 3 and the reagent 6. The liquid bridge 7 refers to a liquid that bridges a space between the probe 3 and the reagent 6. Such a liquid bridge is formed by utilizing surface tension. The liquid bridge 7 is formed in an atmospheric pressure environment. The liquid bridge 7 has a small volume of approximately 1×10⁻¹² m³. The area of the liquid bridge 7 along an in-plane direction of the substrate 2 is approximately 1×10⁻⁸ m².

Voltage application units are provided in order to form a Taylor cone 8 of the liquid at one end (leading end) of the probe 3. The voltage application units include a probe side voltage application unit 5 for applying a voltage to the probe 3 and an ion extract electrode side voltage application unit 11 for applying a voltage to an ion extract electrode 10. A large potential difference (in absolute values, 1 kV or more but 10 kV or less, or preferably 3 kV or more but 5 kV or less,) between the liquid on the probe 3 and the ion extract electrode 10 causes the liquid to form the Taylor cone 8. The Taylor cone 8 has a conical shape with the apex thereof oriented toward the ion extract electrode 10.

The charged liquid at the apex of the Taylor cone 8 is pulled off the Taylor cone 8 to form charged liquid droplets 9, and the charged liquid droplets 9 are then emitted to (sprayed on) the ion extract electrode 10.

Substances contained in the liquid droplets 9 are introduced into a mass spectrometry device 12 in an ionized state. The mass spectrometry device 12 measures a mass-to-charge ratio. Note that a series of processes including formation of the Taylor cone 8, spraying of the charged liquid droplets 9, and ionization is referred to as electrospray ionization, hereinafter. In this way, substances in the reagent 6 that have dissolved in the liquid are ionized at the leading end portion of the probe 3.

An irradiation unit 14 that emits laser light includes a light source that is arranged to irradiate a region of the sample 13 held on the substrate 2 with the laser light. The support 1 includes a vibration unit 19, and the vibration unit 19 causes the liquid bridge 7 to vibrate.

As a system for observing a focus position of the laser light, a camera for observing the focus position may be included in the irradiation unit 14. Then, by observing light from the focus position with the camera and by adjusting the position of the irradiation unit 14 or the sample 13, the sample 13 can be irradiated with the laser light efficiently. When observing the focus position of the laser light, it is preferable to use an optical filter that transmits light in the wavelength band of the laser light. A positioning device such as a stepping motor may be provided to adjust the position of the irradiation unit 14 or the sample 13, and such a positioning device can be connected to the irradiation unit 14 or the support 1.

The spot size of the laser light on the sample 13 has an area of approximately 1×10⁻¹² m² or greater. The spot size can be changed as desired depending on the laser light focusing lens (not illustrated). The laser light is pulsed light having a pulse duration in a femtosecond to nanosecond range and a power of 10 J/m² or greater. The wavelength of the laser light may be in any of an ultraviolet range, a visible range, and an infrared range.

Upon a region of the sample 13 being irradiated with the laser light, fine particulate matter 15 is desorbed from the surface of the sample 13. Then, the charged liquid droplets 9 generated at the leading end of the probe 3 collide with the fine particulate matter 15, and charges are exchanged between the charged liquid droplets 9 and the fine particulate matter 15. Thus, the fine particulate matter 15 is ionized. The ionized fine particulate matter 15 is guided to the ion extract electrode 10 (not illustrated).

The ion extract electrode 10 is a structural member for forming a flow channel for attracting ions contained in the liquid droplets 9 separated from the Taylor cone 8 and the ionized fine particulate matter 15 generated as the charged liquid droplets 9 and the fine particulate matter 15 exchange charges (hereinafter, these ions are generally referred to as ions) and, for example, is cylindrical in shape. A pump (not illustrated) is connected to the ion extract electrode 10, and the ions are attracted to the ion extract electrode 10 along with an outside atmosphere, that is, surrounding gas molecules. The ions pass through the ion extract electrode 10 in the forms of liquid droplets or in a gaseous state. Then, the ions fly in a gaseous state in the mass spectrometry device 12. The mass spectrometry device 12 is a time of flight (TOF) mass spectrometer that utilizes a TOF method. The ions fly through a vacuum flight space within the mass spectrometry device 12 and their mass-to-charge ratios are measured.

In this way, with the ionization device according to the first exemplary embodiment, a portion of a substance obtained from biological tissue serving as the sample 13 can be desorbed by using the laser light, and the desorbed components can be mixed with the reagent 6 in an emission space and ionized. In the first exemplary embodiment, a single type of reagent 6 provided on the substrate 2 is mixed with the desorbed components obtained from biological tissue, and thus the desorbed components are ionized. In a third exemplary embodiment and a fourth exemplary embodiment to be described later, a plurality of reagents is used.

An image generation system according to the first exemplary embodiment includes a mass spectrometer and an image generation device, and the mass spectrometer includes an ionization unit and a mass spectrometry unit.

The ionization unit includes the support 1, the substrate 2 on which the sample 13 and the reagent 6 are held, the probe 3, the irradiation unit 14, the ion extract electrode 10, the liquid supply unit 4, and the voltage application units 5 and 11.

As stated above, the laser light hits an extremely small region of the surface of the sample 13. In order to analyze a larger area of the surface of the sample 13, a moving unit 16 for moving the sample 13 in the in-plane direction thereof is provided on the support 1. The moving unit 16 is connected to an analysis position specification unit 17, and the analysis position specification unit 17 is connected to the mass spectrometry device 12. The analysis position specification unit 17 specifies a region of the sample 13 to be analyzed by the mass spectrometry device 12, and the mass spectrometry device 12 analyzes positional information of the specified position and the mass of the components in the sample 13 at the specified position.

The analysis position specification unit 17 corresponds to the image generation device that generates image information by obtaining positional information and mass spectrometry information.

The image information may be for a two-dimensional image or a three-dimensional image. The image information outputted from an output unit (not illustrated) of the analysis position specification unit 17 is sent to an image display unit 18 such as a flat panel display connected to the analysis position specification unit 17. The image information is inputted to the image display unit 18 and displayed in the form of an image. In the image, the positions of the components detected by the mass spectrometry device 12 are mapped on an image of the sample 13 that has been optically captured in advance. In addition to the position of the component, the amount of the component is also displayed, and differences in the amount are indicated by varying colors or brightness.

The image to be displayed on the display may be, aside from such a mapping image, a mass spectrum as indicated in the right side of the image display unit 18 in FIG. 1.

The vibration unit 19 is connected to the support 1 and is used to increase the number of ions to be obtained when the reagent 6 dissolved in the liquid bridge 7 is ionized.

Here, the substance obtained from biological tissue is used as the sample 13, the mixture containing water, an organic solvent, and an acid or a base is used as the solvent, and a solute that easily dissolves in the mixture is used as the reagent 6. Alternatively, an ionization device according to an exemplary embodiment of the present invention can be applied to other combinations of a sample, a solvent, and a reagent as well. For example, the ratio of water, an organic solvent, and an acid or a base in a solvent can be varied. One of the components in a given ratio may, for example, be 0, that is, one of the components may not be contained. Varying the ratio allows solubility, in the mixture, of a water-soluble molecule and a fat-soluble molecule contained in the reagent 6 to be varied, and thus ionization of a desired molecule can be prioritized.

In the ionization device according to the first exemplary embodiment, the voltage application unit 5 applies a voltage to the solvent, and in this case the probe 3 is preferably an insulator. Alternatively, an ionization device according to an exemplary embodiment of the present invention may be configured such that the voltage application unit 5 applies a voltage to the probe 3 and, as a result, the voltage is applied to the solvent. In this case, the probe 3 is preferably formed of a conductor, and the solvent is disposed so as to be in contact with the conductor.

In the ionization device according to the first exemplary embodiment, the probe 3 has a flow channel formed therein, and the solvent flows in the flow channel. Alternatively, an ionization device according to an exemplary embodiment of the present invention may be configured such that the liquid supply unit 4 supplies liquid droplets to the probe 3 and the liquid droplets flow along the outer surface of the probe 3 to the leading end thereof so as to form the liquid bridge 7.

In the ionization device according to the first exemplary embodiment, the probe 3 has a flow channel formed therein. Alternatively, an ionization device according to an exemplary embodiment of the present invention may include a plurality of flow channels, and distinct solvents may flow in the respective flow channels. In this case, a unit configured to apply distinct voltages to the respective solvents may be provided.

In the ionization device according to the first exemplary embodiment, the ion extract electrode 10 is connected to the voltage application unit 11 that is configured to apply a voltage to the ion extract electrode 10. In this case, the ion extract electrode 10 preferably includes a conductive member, and this conductive member is preferably connected to the voltage application unit 11.

Alternatively, an ionization device according to an exemplary embodiment of the present invention may be configured such that the ion extract electrode 10 is formed of an insulator and a conductive member is disposed on the ion extract electrode 10 at an end that is close to the probe 3. Then, the voltage application unit 11 may be connected to the conductive member so as to apply a high electric field to the Taylor cone 8.

The ionization device according to the first exemplary embodiment may be used as an ion generation unit not only of a TOF mass spectrometer but also of a quadrupole mass spectrometer, a magnetic field deflection mass spectrometer, ion trap mass spectrometer, and ion cyclotron mass spectrometer.

In the ionization device according to the first exemplary embodiment, the liquid bridge 7 is formed in an atmospheric pressure environment and the substance is ionized. Here, the atmospheric pressure covers a range of 0.1 to 10 times the standard atmospheric pressure of 101325 Pa. Alternatively, the environment may be in an atmosphere that is the same as a typical room environment, or in an inert gas atmosphere such as a nitrogen atmosphere or an argon atmosphere.

The ionization device according to the first exemplary embodiment is configured such that the solvent continuously flows in the flow channel formed in the probe 3 at a constant flow rate. Alternatively, the flow rate (flow speed) of the solvent may be controlled. That is, an increase or a decrease in the flow rate can be set as desired. Thus, by increasing the flow rate if the amount of the reagent 6 is large or decreasing the flow rate if the amount of the reagent 6 is small, a fluctuation in the concentration of the substance dissolved in the liquid bridge 7 can be suppressed, and the substance in the reagent 6 can be ionized efficiently.

In the ionization device according to the first exemplary embodiment, the fine region of the sample 13 is irradiated with the laser light continuously. Alternatively, the fine region may be irradiated with the laser light intermittently during a given period of time. That is, the sample 13 may be irradiated with the laser light for a given period of time, and then the irradiation may be stopped for another given period of time. Accordingly, a period in which the laser light interacts with a substance that is easily decomposed by the laser light can be reduced, and thus decomposition of the substance can be suppressed. In addition, the above configuration can suppress a situation where the fine region of the sample 13 is locally heated by the laser light, and thus degradation of the substance to be caused by the heat can be suppressed.

In the ionization device according to the first exemplary embodiment, a voltage is steadily applied to the ion extract electrode 10. Alternatively, a timing of the laser light irradiation and a timing of applying a voltage to the ion extract electrode 10 may be adjusted as desired. For example, a voltage may be applied to the ion extract electrode 10 for a given period of time immediately after the start of laser light irradiation. Then, unnecessary ions generated during a period in which the laser light is not radiated are not detected, and thus ions generated immediately after the laser light starts being radiated can be collected efficiently. That is, ions of the solvent components in the charged liquid droplets 9 generated from the Taylor cone 8 are prevented from being detected while the charged liquid droplets 9 do not interact with the desorbed fine particulate matter 15. Thus, unnecessary ions can be prevented from being taken into the mass spectrometer, and a noise component in an obtained analysis result can be suppressed.

In the ionization device according to the first exemplary embodiment, a mixed solvent is supplied to the probe 3 to cause the solid reagent 6 on the substrate 2 to dissolve. Alternatively, the reagent 6 on the substrate 2 may be in a liquid state. In this case, the liquid supply unit 4 can be paused. Further, a probe 3 without a flow channel formed therein can be used instead.

### Second Exemplary Embodiment

An ionization device according to a second exemplary embodiment of the present invention has a configuration in which one end of the probe 3 is caused to vibrate. Points aside from the above are identical to those of the first exemplary embodiment.

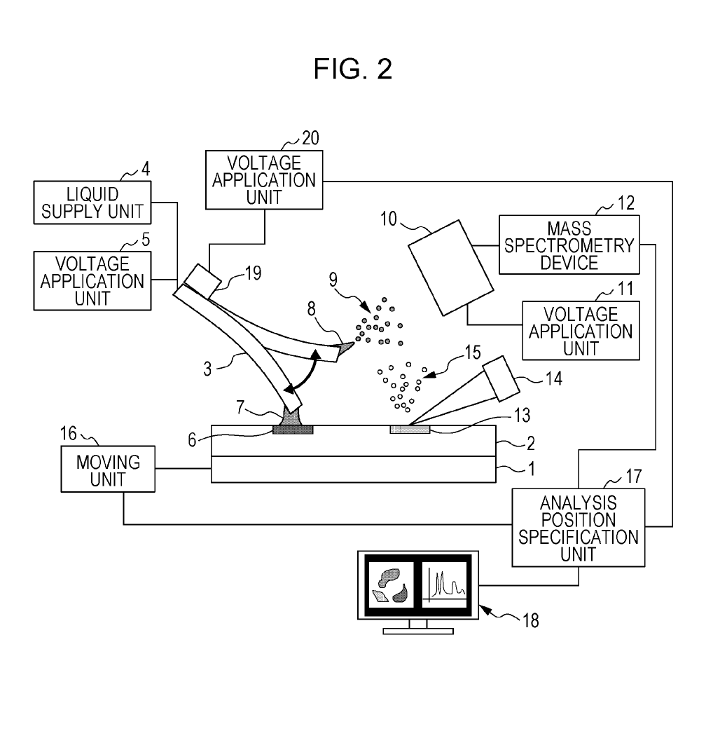

FIG. 2 is a schematic diagram illustrating an image generation system that includes the ionization device according to the second exemplary embodiment of the present invention. In the ionization device according to the second exemplary embodiment, the vibration unit 19 is provided on the probe 3 instead of the support 1. The vibration unit 19 is connected to a voltage application unit 20, which is then connected to the analysis position specification unit 17. The vibration unit 19 causes the probe 3 to vibrate in directions indicated by an arrow in FIG. 2.

The vibration unit 19 is formed by a piezoelectric element or a motor element and causes the probe 3 to vibrate. The amplitude of the vibration of the probe 3 is approximately a few tens of nanometers to a few millimeters, and the frequency is approximately 10 Hz or more and up to 1 MHz.

The probe 3 vibrates continuously, and if the probe 3 makes contact with the reagent 6 while vibrating, the liquid bridge 7 is formed between the probe 3 and the reagent 6. If the probe 3 is separated from the reagent 6 while vibrating, the liquid bridge 7 is not formed, but the Taylor cone 8 is generated and the liquid droplets 9 are sprayed. In this way, the reagent 6 is ionized at the end of the probe 3.

In the second exemplary embodiment, unlike the first exemplary embodiment, the distance between the end of the probe 3 and the ion extract electrode 10 changes dynamically. The distance is decreased from when the liquid bridge 7 is formed until the Taylor cone 8 is formed, and thus the electric field strength to which the liquid at the leading end of the probe 3 is subjected is enhanced. Further, vibration of the probe 3 causes inertia to act on the liquid at the end of the probe 3, and thus the liquid is emitted in the vibration direction. In the second exemplary embodiment, the vector of the vibration of the probe 3 is substantially parallel to (i.e., in the same direction as) the vector of the electric field, and thus the efficiency of electrospray is improved as compared to that of the first exemplary embodiment.

In the ionization device according to the second exemplary embodiment, the vibration unit 19 causes the probe 3 to vibrate. Alternatively, spontaneous resonance of the probe 3 may be utilized without providing a vibration unit. This is considered to be possible if, for example, the size and the material of the probe 3, the size of the flow channel formed in the probe 3, the voltage applied thereto, and the flow rate of the solvent are set as follows.

Size of probe: 10 μm to 100 mm in length
Material: any one of glass, stainless steel, silicon, PMMA
Size of flow channel: 1 μm² to 1 mm² in cross section
Applied voltage: 0 V to ±10 kV
Flow rate of solvent: 1 nL to 1000 μL per minute

In the ionization device according to the second exemplary embodiment, the vibration unit 19 vibrates continuously. Alternatively, the vibration unit 19 may vibrate intermittently. Here, “vibrating intermittently” refers to a case in which states where the probe 3 vibrates and is stopped are repeated alternately or a case in which the amplitude and/or the cycle of vibration of the probe 3 change repeatedly.

The vibration frequency to be set in the vibration unit 19 may be a resonance frequency or a non-resonance frequency.

In the ionization device according to the second exemplary embodiment, the probe 3 vibrates between the reagent 6 and the ion extract electrode 10 but may instead be rotated. If the probe 3 is to rotate, a desired vibration in two axial directions that are orthogonal to each other may be given to the probe 3. In this case, the probe 3 vibrates in a combined wave pattern of two sine waves.

In the ionization device according to the second exemplary embodiment, the liquid supply unit 4 continuously supplies the liquid to a space between the probe 3 and the reagent 6. Alternatively, in an exemplary embodiment of the present invention, the liquid supply unit 4 may supply the liquid to a space between the probe 3 and the reagent 6 while the probe 3 is in close proximity to (or in contact with) the reagent 6 and may stop supplying the liquid while the probe 3 is spaced apart from the reagent 6. That is, the supply of the liquid and the vibration of the probe 3 may be synchronized.

The vibration of the probe 3 in the ionization device according to the second exemplary embodiment can be detected with various methods. For example, a side face of the probe 3 may be irradiated with laser light that is different from the laser light with which the sample 13 is to be irradiated, and displacement of reflected light from the probe 3 may be detected. As another example, an electric element for detecting a vibration may be connected to the probe 3, and distortion in the probe 3 may be detected on the basis of a change in electric resistance of the element. As yet another example, a magnetic member may be connected to the probe 3, and a change in an induced current that flows in a coil disposed close to the probe 3 may be detected.

In the ionization device according to the second exemplary embodiment, the sample 13 may be irradiated with the laser light intermittently during a given period of time, as in the first exemplary embodiment. Thus, duration for which a substance that is easily decomposed by the laser light is exposed to the laser light can be reduced. Further, the above configuration makes it possible to suppress a situation where the sample 13 is locally heated due to being irradiated with the laser light intermittently. If the probe 3 vibrates, synchronization of the formation of the Taylor cone 8 and the timing of the laser light irradiation can be achieved by adjusting the frequency and the phase of the vibration of the probe 3 and the frequency and the phase of a control signal for the laser light. It is preferable to synchronize a signal obtained by monitoring the vibration of the probe 3 with a signal for controlling an irradiation timing of the laser light using a synchronization circuit.

In the ionization device according to the second exemplary embodiment, a constant voltage is applied to the ion extract electrode 10 continuously. Alternatively, the vibration timing of the probe 3 and the timing of applying a voltage to the ion extract electrode 10 (i.e., on/off timings or a change in the voltage) may be synchronized. Then, unnecessary ions generated during a period in which the liquid bridge 7 is formed are not detected, and thus noise in the obtained measurement data can be reduced. Here, the synchronization of the vibration timing of the probe 3 with the timing of the laser light irradiation described above may be carried out additionally.

Synchronization of the formation of the liquid bridge 7, irradiation of the laser light, and the timing of applying a voltage to the ion extract electrode 10 can be achieved by adjusting the frequencies and the phases of the vibration of the probe 3, the control signal for the laser light, and the control signal for voltage application. These signals are preferably synchronized through a synchronization circuit.

### Third Exemplary Embodiment

In an ionization device according to a third exemplary embodiment of the present invention, a substrate includes a plurality of holding units for holding reagents. Points aside from the above are identical to those of the first or second exemplary embodiment.

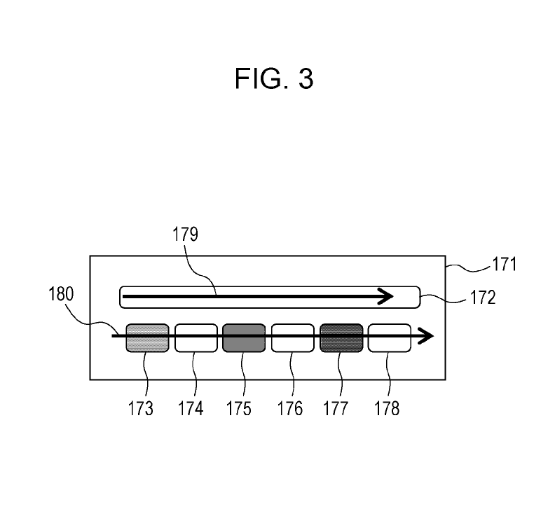

FIG. 3 is a schematic diagram illustrating a face of a substrate included in a support of the ionization device according to the third exemplary embodiment. A sample 172, holding units 173, 175, 177 for holding reagents, and cleaning units 174, 176, 178 serving as removing units are provided in a substrate 171. The sample 172 is arranged in one direction. The holding units 173, 175, 177 for holding the reagents are aligned in the same direction as the direction in which the sample 172 is arranged. The cleaning units 174, 176, 178 are provided so as to alternate with the holding units 173, 175, 177.

The laser light moves in a direction of an arrow 179 relative to the sample 172, and a probe moves in a direction of an arrow 180 relative to the holding units 173, 175, 177. The substrate 171 is moved by the moving unit 16 provided on the support 1. As a result, the laser light and the probe scan in the directions indicated by the respective arrows 179 and 180. That is, the laser light and the probe move, respectively, relative to the sample 172 and the holding units 173, 175, 177. According to the third exemplary embodiment, a distinct reagent can be used in each location of the sample 172, and thus the purpose and the result of measurement can be varied for each location of the sample 172. The probe passes through the holding unit 173 and then passes through the cleaning unit 174. Then, the probe sequentially passes through the holding unit 175, the cleaning unit 176, the holding unit 177, and the cleaning unit 178. The holding units 173, 175, 177 each hold a distinct reagent. Since the probe passes through a cleaning unit while moving through a space between two holding units, unwanted substances such as a reagent from a previous holding unit on the probe can be removed, and contamination of another reagent can be prevented. To be more specific, a situation where a plurality of reagents has adhered on the end of probe can be prevented.

Each of the cleaning units 174, 176, 178 may be a recess formed in the surface of the substrate 171, similarly to the holding units 173, 175, 177. A cleaning liquid or a porous material for absorbing the reagent may be provided in the recess. Further, the holding units 173, 175, 177 may each include a substance in which a porous material and a hydrophobic material are mixed. As the reagent is held in a porous material, the reagent can be prevented from diffusing on the substrate. In addition, as a hydrophobic material is provided, a liquid bridge is less likely to spread along the in-plane direction, and thus the reagent can be contained in the liquid bridge in larger quantity. If the holding units 173, 175, 177 each include a material in which a porous material and a hydrophobic material are mixed, the recesses do not need to be formed.

### Fourth Exemplary Embodiment

An ionization device according to a fourth exemplary embodiment of the present invention includes a substrate in which a component passage through which a liquid containing a component extracted from a sample passes is disposed so as to extend in one direction. Points aside from the above are identical to those of the third exemplary embodiment.

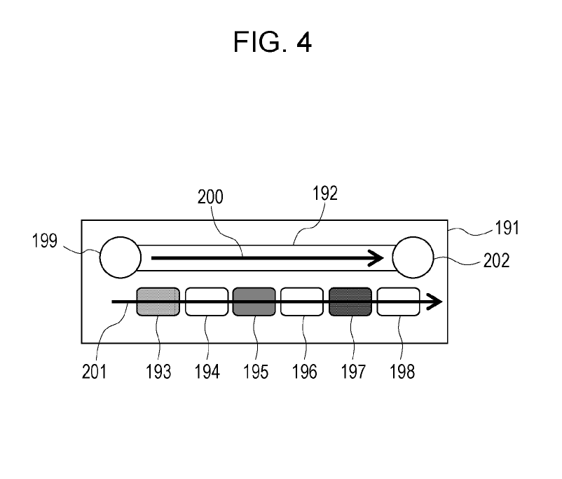

FIG. 4 is a schematic diagram illustrating a face of a substrate included in a support of the ionization device according to the fourth exemplary embodiment.

A component passage 192 is provided in a substrate 191. Furthermore, holding units 193, 195, 197 for holding reagents and cleaning units 194, 196, 198 are provided in the substrate 191. The laser light scans in a direction of an arrow 200, and the probe scans in a direction of an arrow 201, similarly to the third exemplary embodiment. The component passage 192 includes a porous material, and a sample placement unit 199 is connected to one end of the component passage 192. When a liquid is applied to a sample placed on the sample placement unit 199, components in the sample are taken into the liquid, and that liquid passes through the component passage 192 toward the other end 202. The porous material in the component passage 192 separates a plurality of components that has been taken into the liquid from the sample, and the components are expanded on the component passage 192. A voltage may be applied across the component passage 192 to facilitate the movement of the components.

Further, the component passage 192 may include a material that interacts with the components, instead of the aforementioned porous material that utilizes affinity with the components. For example, an antigen-antibody reaction between the components and the component passage 192 may be used. If the components include a specific protein, an antibody molecule that bonds with that protein may be provided in the component passage 192.

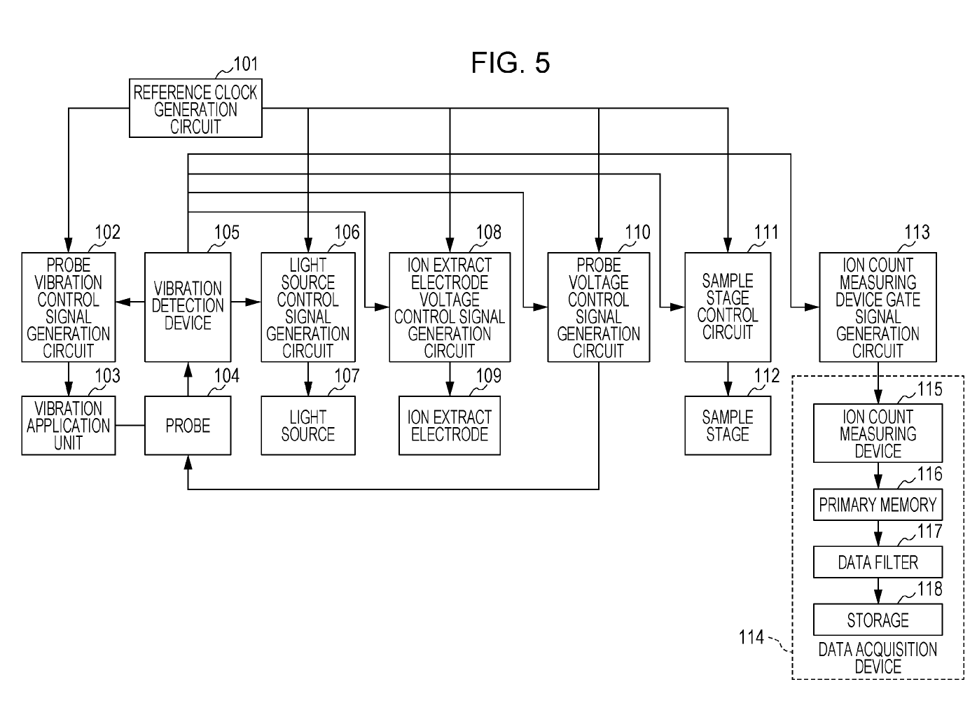

In the ionization device according to the above exemplary embodiments, it is necessary to precisely adjust the timing at which a probe vibrates, the timing of laser light irradiation, application of a voltage to an extract electrode, a voltage applied to the probe, the timing at which a sample stage is moved, and acquisition and storage of data. An exemplary embodiment of a synchronization circuit for achieving the above is illustrated in FIG. 5.

The synchronization circuit of the exemplary embodiment includes a reference clock generation circuit 101, a probe vibration control signal generation circuit 102, a vibration application unit 103, a probe 104, a vibration detection device 105, a light source control signal generation circuit 106, a light source 107, an extract electrode voltage control signal generation circuit 108, an extract electrode 109, a probe voltage control signal generation circuit 110, a sample stage control circuit 111, a sample stage 112, an ion count measuring device gate signal generation circuit 113, and a data acquisition device 114. The data acquisition device 114 includes an ion count measuring device 115, a primary memory 116, a data filter 117, and a storage 118.

Here, a case where a field programmable gate array (FPGA) or an application specific integrated circuit (ASIC) is used will be described as an example. The use of the FPGA or the ASIC makes it possible to implement a plurality of control circuits (i.e., reference clock generation circuit 101, probe vibration control signal generation circuit 102, light source control signal generation circuit 106, extract electrode voltage control signal generation circuit 108, probe voltage control signal generation circuit 110, sample stage control circuit 111) on an integrated circuit and to precisely adjust their control timings at high speed.

The probe vibration control signal generation circuit 102, the light source control signal generation circuit 106, the extract electrode voltage control signal generation circuit 108, the probe voltage control signal generation circuit 110, the sample stage control circuit 111, and the ion count measuring device gate signal generation circuit 113 generate respective voltage signals and output the generated voltage signals to the vibration application unit 103, the light source 107, the extract electrode 109, the probe 104, the sample stage 112, and the ion count measuring device 115, respectively. Each of these voltage signals may be any one of a triangular wave, a square wave, a sine wave, and a cosine wave.

A feedback circuit is formed in the probe vibration control signal generation circuit 102 in order to bring a phase difference between a voltage signal obtained by detecting an actual vibration of the probe 104 and a voltage signal generated on the basis of a reference clock to zero, and driving this feedback circuit allows the probe 104 to vibrate at a constant frequency. The vibration detection device 105 is used to detect the actual vibration of the probe 104, and an output signal from the vibration detection device 105 is inputted to the feedback circuit in the probe vibration control signal generation circuit 102. Such a drive mechanism is known as a phase locked loop (PLL). Providing a delay compensation circuit within a circuit for the PLL makes it possible to generate a voltage signal having a desired delay time relative to a reference signal.

The output signal from the vibration detection device 105 is also inputted to the light source control signal generation circuit 106, the extract electrode voltage control signal generation circuit 108, the probe voltage control signal generation circuit 110, the sample stage control circuit 111, and the ion count measuring device gate signal generation circuit 113. Certain times such as a timing at which the probe 104 forms a liquid bridge, a timing at which ionization occurs at the leading end of the probe 104, and a timing between the liquid bridge formation and the ionization are extracted on the basis of the inputted voltage signals, and driving of the devices that are connected to the respective circuits at the aforementioned timings are controlled. For example, a signal of displacement of the probe 104 serves as an output signal from the vibration detection device 105, and when this signal is inputted to the light source control signal generation circuit 106, the extract electrode voltage control signal generation circuit 108, the probe voltage control signal generation circuit 110, and the sample stage control circuit 111, a specific threshold voltage may be set. Then, a period in which a voltage falls below the threshold voltage can be set as a timing of forming a liquid bridge, or a period in which a voltage exceeds the threshold voltage can be set as a timing at which ionization occurs. Then, a timing at which a voltage is applied to the probe 104, a timing at which the light source 107 emits light, a timing at which a voltage is applied to the extract electrode 109, and a timing at which the sample stage 112 is moved are controlled so as to synchronize with the timings determined as described above. Further, using a signal from the reference clock generation circuit 101 makes it possible to quantitatively measure and to control a timing at which a voltage is applied to the probe 104, a timing at which the light source 107 emits light, a timing at which a voltage is applied to the extract electrode 109, and a timing at which the sample stage 112 is moved.

An output signal generated by the ion count measuring device gate signal generation circuit 113 is inputted to the ion count measuring device 115 as a gate voltage signal. Generally, the ion count measuring device 115 intermittently receives a trigger signal from the mass spectrometer, and after receiving the trigger signal, the ion count measuring device 115 measures the number of ions that have reached the detector in the mass spectrometer. A trigger signal differs depending on the configuration of an ion separation unit in the mass spectrometer. In the exemplary embodiment, a quadrupole mass spectrometer, a TOF mass spectrometer, a magnetic field deflection mass spectrometer, or an ion trap mass spectrometer may be used as the mass spectrometer, and a specific timing may be used as a trigger signal for each instance of mass spectrometry.

For example, a signal indicating a timing of starting application of a high frequency voltage to a quadrupole electrode may be used as a trigger signal in the quadrupole mass spectrometer. In the TOF mass spectrometer, a signal indicating a timing of application of a pulse voltage for accelerating an ion in a device that measures the time of flight of the ion may be used as a trigger signal. In the magnetic field deflection mass spectrometer, a signal indicating a timing at which a magnetic field starts to be applied to a sector electrode may be used as a trigger signal. In the ion trap mass spectrometer, a signal indicating a timing at which an ion is introduced to an ion trap may be used as a trigger signal. Typically, the frequency of the pulse voltage in the TOF mass spectrometer is approximately a few kHz to a few tens of kHz, and the frequency of trapping ions in the ion trap mass spectrometer is approximately a few tens of Hz to a few kHz. Thus, the frequency is often higher than the vibration frequency of the probe 104.

In the exemplary embodiment, a gate voltage signal is outputted in synchronization with a timing at which ionization occurs at the leading end of the probe 104. The ion count measuring device 115 is configured to operate in accordance with a period in which the gate signal is outputted. Here, the gate signal is any one of a positive voltage, a negative voltage, and a zero voltage and differs depending on the ion count measuring device 115. The ion count measuring device 115 can be configured to operate only while ions are generated at the probe 104, and thus a noise signal is not measured while the liquid bridge is formed and during period from when the liquid bridge is formed until the ionization occurs. Therefore, a noise signal to be contained in a signal of measured data can be reduced.

Subsequently, a method for recording a voltage signal from the ion count measuring device 115 in the form of digital data will be described. A signal from the ion count measuring device 115 undergoes analog-to-digital conversion and is then temporarily stored in the primary memory 116. Measurement data that corresponds to the type of ions to be measured is selected and stored in the storage 118 such as a hard disk drive (HDD) and a solid state drive (SSD). This process of selecting the data is carried out through a program in the data filter 117, and the data is overwritten by new data in the memory. Since the data is stored in the storage 118 after being selected, the total amount of data can be reduced, and the selected data can be applied if the ion to be measured is determined in advance. Meanwhile, if an unknown ion is to be detected, the entire data obtained by the ion count measuring device 115 can be stored in the storage 118.

If a large area on a measurement target is to be measured, the sample stage 112 needs to be moved. The sample stage control circuit 111 generates a signal for controlling the position of the sample stage 112 on the basis of a reference clock and outputs the generated signal to the sample stage 112. At this point, by measuring a timing at which ionization occurs at the leading end of the probe 104 and the number of instances of ionization within a given period of time on the basis of the signal from the vibration detection device 105, the number of instances of ionization per position on a sample can be kept constant. Acquisition and storage of the data can be carried out successively while moving the sample stage 112. Thus, pieces of two-dimensional data on the measurement target can be stored successively.

Thus far, a case where the signal generation circuits generate respective output signals relative to a threshold has been described, but the exemplary embodiments are not limited thereto. A common signal generation circuit may be provided separately, and the common signal generation circuit may extract specific times on the basis of a signal from the vibration detection device 105. Then, the common signal generation circuit may input a voltage signal corresponding to the extracted times to the light source control signal generation circuit 106, the extract electrode voltage control signal generation circuit 108, the probe voltage control signal generation circuit 110, the sample stage control circuit 111, and the ion count measuring device gate signal generation circuit 113.

In the exemplary embodiment, a synchronization method in a case where the probe 104 vibrates has been described. Alternatively, if the probe 104 is paused, the probe vibration control signal generation circuit 102, the vibration application device 103, and the vibration detection device 105 that relate to the vibration of the probe 104 may be stopped, and various control signals may be generated using signals from the reference clock generation circuit 101 in the respective control circuits.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-197208, filed Sep. 7, 2012, which is hereby incorporated by reference herein in its entirety.

What is claimed is:

1. An ionization device, comprising:
a support configured to support a sample;
a laser light irradiation unit configured to irradiate the sample supported on the support with laser light;
a needle configured to hold a liquid at a distal end thereof;
a voltage application unit configured to cause the liquid held at the distal end of the needle to scatter in a space in the form of liquid droplets; and
a reagent holding unit configured to hold a reagent disposed away from the sample,
wherein a substance contained in the sample is ionized and scattered, and
wherein the needle is configured to hold the liquid that includes the reagent that is held by the reagent holding unit.

2. The ionization device according to claim 1,
wherein the sample is arranged on the support in one direction, and
wherein a plurality of holding units is arranged in the same direction as the one direction.

3. The ionization device according to claim 1,
wherein the support includes a component passage that extends in one direction from a position at which the sample is placed, the component passage being a path through which the sample contained in a liquid passes, and
wherein a plurality of holding units is arranged in the same direction as the one direction.

4. The ionization device according to claim 2, further comprising:
a removing unit provided between the plurality of holding units, the removing unit being configured to remove the reagent from the needle.

5. The ionization device according to claim 2, wherein the needle and the laser light move in the one direction.

6. The ionization device according to claim 5, wherein the needle and the laser light move in the one direction relative to the sample with a positional relationship between the needle and the laser light being retained.

7. The ionization device according to claim 1, further comprising:
a vibration unit configured to cause the needle to vibrate.

8. The ionization device according to claim 1, further comprising:
a vibration unit configured to cause the sample to vibrate.

9. The ionization device according to claim 1, further comprising:
a synchronization circuit configured to synchronize a timing of laser light irradiation with a timing at which one of the sample and the needle vibrates.

10. The ionization device according to claim 1, further comprising:
a synchronization circuit configured to synchronize a timing of laser light irradiation with a timing at which a voltage is applied to the voltage application unit.

11. The ionization device according to claim 1, further comprising:
a synchronization circuit configured to synchronize a timing of laser light irradiation with an operation timing of an ion count measuring device connected to the ionization device.

12. The ionization device according to claim 1, further comprising:
a synchronization circuit configured to synchronize a timing of laser light irradiation with a timing at which a voltage is applied to an ion extract electrode of the ionization device.

13. The ionization device according to claim 1, further comprising:
a synchronization circuit configured to synchronize a timing of laser light irradiation with at least two of a timing at which one of the sample and the needle vibrates, a timing at which a voltage is applied to the voltage application unit, an operation timing of an ion count measuring device connected to the ionization device, and a timing at which a voltage is applied to an ion take-in extract electrode of the ionization device.

14. A mass spectrometer, comprising:
the ionization device according to claim 1; and
an analysis device configured to analyze a mass of the ionized substance.

15. An image generation device, comprising:
a unit configured to obtain positional information of the mass that has been analyzed by the mass spectrometer according to claim 14; and
a unit configured to display a position of the substance on an image of the sample displayed by an image display device.

16. A substrate, comprising:
a plurality of reagent holding units; and
a plurality of removing units,
wherein the substrate is supported by the support of the ionization device according to claim 1 so as to be movable relative to the needle, and
wherein the reagents holding units are arranged so as to alternate with the removing units in a direction in which the substrate is movable relative to the needle.
